(19) United States
(12) Patent Application Publication
(10) Pub. No.: US 2004/0128361 A1
(43) Pub. Date: Jul. 1, 2004

(54) Transferring a multimedia file

(76) Inventor: William J. Gaffney, Cumming, GA (US)

Correspondence Address: TECHNOPROP COLTON, L.L.C., P O BOX 567685, ATLANTA, GA, 311567685

(21) Appl. No.: 10/311,172

(22) PCT Filed: Jun. 6, 2001
(86) PCT No.: PCT/US01/18303

(51) Int. Cl. G06F 15/16

(52) U.S. Cl. 709/217; 709/203

(57) ABSTRACT

A system for transferring a multimedia file between a server (101) computer and a local computer (107), including: a graphical user interface generation element for generating a graphical user interface through which the functions of the system are controlled by a user; a multimedia file transfer element for transferring the multimedia file between the server and the local computer; a multimedia file type detection element for detecting the type of multimedia file being transferred; and a graphical user interface control element for being adapted to control the graphical user interface generation element. The system may also include a stand-alone multimedia file output device in the form of a toy for receiving and playing back the multimedia file.

### BACKGROUND OF THE INVENTION

1. Field of the Invention

The instant invention relates to a system, software program, and method for transferring a multimedia file among a server computer, a local computer, and a stand-alone multimedia file output device.

More particularly, the instant invention relates to a system, software program, and method for transferring a multimedia file among a server computer, a local computer, and a stand-alone multimedia file output device, wherein the multimedia file output device is a toy.

2. Description of the Related Art

The Internet is a vastly popular and incredibly useful system for transferring information and electronic files. For example, there are a tremendous number of websites published on the Internet where electronic files of almost any conceivable format may be found and downloaded. These include websites for downloading executable files, image files, and multimedia files (that is, files containing audio and/or video content).

As seen in FIG. 1, the conventional arrangement is that Server 101 hosts Website 103. Downloading files from Website 103 via the Internet 105 to Local Computer 107 (running, for example, a WINDOWS operating system, not shown) involves using a Web Browser 109 (such as Netscape Communications Corporation's Navigator or Microsoft Corporation's Internet Explorer) to “navigate” to the Website 103 and “click” on a desired file. The integrated downloading capability of the Web Browser 109 then takes over the file transfer work after asking the user a question such as “Where on your computer do you want to store the file?”.

This conventional file downloading technique suffers a number of disadvantages. To begin with, young or inexperienced users might not know where an appropriate area is on their computer to store the file. Further, young or inexperienced users likely do not care where the file is downloaded to and stored as long as the software that they use to manipulate the file can find it. Thus, the above-mentioned file download turns out to be more complex and burdensome than necessary.

This particular disadvantage of the conventional Web Browsers appears to have been addressed by the REAL JUKEBOX software by REAL AUDIO. By writing a number of entries to the WINDOWS registry the REAL JUKEBOX software is able to instruct the conventional Web Browsers to automatically download REAL AUDIO MP3 files to a “jukebox” area of the computer's hard drive whenever such REAL AUDIO MP3 files are “navigated” to and “clicked” on.

Nevertheless, there is an even more important disadvantage suffered by conventional Web Browsers and the REAL JUKEBOX software that is not addressed by the REAL AUDIO system. That is, these software programs are general-purpose software programs that try to reach as broad an audience as possible and to present as consistent an appearance as possible. There is no facility for changing the Graphical User Interface in dependence upon what type of file is being downloaded. Such a shortcoming prohibits, for example, the display of entertaining or informative Graphical User Interfaces appropriate to specific file types. More particularly, such a shortcoming prohibits the display of file-specific entertaining or informative Graphical User Interfaces to children, who are most likely to lose interest in the conventional static, unchanging Graphical User Interfaces.

### OBJECTS AND SUMMARY OF THE INVENTION

It is therefore an object of the present invention to provide a system for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another. The system may comprise graphical user interface generation means associated with the local computer for generating a graphical user interface through which the functions of the system are controlled by a user; multimedia file transfer means associated with the local computer for transferring the multimedia file between at least two of the mass storage device of the server computer, the fixed mass storage device of the local computer, and the removable mass storage device of the local computer; multimedia file type detection means associated with the local computer for detecting the type of multimedia file being transferred by the multimedia file transfer means; and graphical user interface control means associated with the local computer, the graphical user interface control means being in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

Another object of the present invention is to provide a software program for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another. The software program may comprise graphical user interface generation means for generating a graphical user interface through which the functions of the software program are controlled by a user; multimedia file transfer means for transferring the multimedia file between at least two of the mass storage device of the server computer, the fixed mass storage device of the local computer, and the removable mass storage device of the local computer; multimedia file type detection means for detecting the type of multimedia file being transferred by the multimedia file transfer means; and graphical user interface control means in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

Another object of the present invention is to provide a software program for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another. The software program may comprise graphical user interface generation means for generating a graphical user interface through which the functions of the software program are controlled by a user; multimedia file transfer means for transferring the multimedia file between at least two of the mass storage device of the server computer, the fixed mass storage device of the local computer, the removable mass storage device of the local computer, and the multimedia file output device; multimedia file type detection means for detecting the type of multimedia file being transferred by the multimedia file transfer means; multimedia file output device type detection means for detecting the type of multimedia file output device operatively connected to the local computer; and graphical user interface control means operatively connected to the multimedia file type detection means, the multimedia file output device type detection means, and the graphical user interface generation means for receiving an indication of i) the multimedia file type detected by the multimedia file type detection means and ii) the multimedia file output device type detected by the multimedia file output device type detection means for controlling the graphical user interface generation means to generate a graphical user interface specific to at least one of i) a particular type of multimedia file being transferred by the multimedia file transfer means and ii) a particular type of multimedia file output device operatively connected to the local computer.

Another object of the present invention is to provide a method for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another. The method may comprise generating a graphical user interface through which the functions of a software program are controlled by a user; transferring the multimedia file between at least two of the mass storage device of the server computer, the fixed mass storage device of the local computer, and the removable mass storage device of the local computer; detecting the type of multimedia file being transferred; and modifying the graphical user interface into a form specific to a particular type of multimedia file being transferred by the multimedia file transfer means.

Another object of the present invention is to provide a method for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another. The method may comprise generating a graphical user interface through which the functions of a software program are controlled by a user; transferring the multimedia file between at least two of the mass storage device of the server computer, the fixed mass storage device of the local computer, the removable mass storage device of the local computer, and the multimedia file output device; detecting the type of multimedia file being transferred; detecting the type of multimedia file output device operatively connected to the local computer; and modifying the graphical user interface into a form specific to at least one of i) a particular type of multimedia file being transferred and ii) a particular type of multimedia file output device operatively connected to the local computer.

Other objects and advantages will become apparent from the detailed description, claims, and accompanying drawings.

### BRIEF DESCRIPTION OF THE DRAWINGS

FIG. 1 shows a block diagram of a system for downloading files from the Internet according to the prior art;

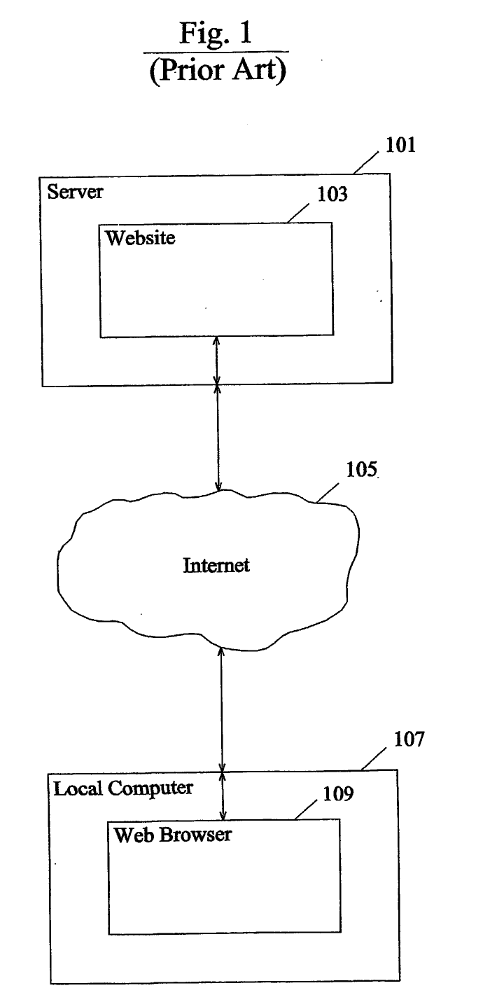

FIG. 2 shows a block diagram of a first embodiment of the instant invention;

FIG. 3 shows a more detailed block diagram of the Multimedia File Management Software of FIG. 2;

FIG. 4 shows a more detailed block diagram of the Record And Send Software of FIG. 2;

FIG. 5 shows a block diagram of a second embodiment of the instant invention;

FIG. 6 shows a more detailed block diagram of the Multimedia File Management Software of FIG. 5;

FIG. 7 shows a more detailed block diagram of the Record And Send Software of FIG. 5;

FIG. 8 shows a block diagram of a third embodiment of the instant invention;

FIG. 9 shows a more detailed block diagram of the Multimedia File Management Software of FIG. 8; and

FIG. 10 shows a more detailed block diagram of the Record And Send Software of FIG. 8.

### DETAILED DESCRIPTION OF THE PREFERRED EMBODIMENTS

A system for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another is provided, comprising graphical user interface generation means associated with the local computer for generating a graphical user interface through which the functions of the system are controlled by a user; multimedia file transfer means associated with the local computer for transferring the multimedia file between at least two of the mass storage device of the server computer, the fixed mass storage device of the local computer, and the removable mass storage device of the local computer; multimedia file type detection means associated with the local computer for detecting the type of multimedia file being transferred by the multimedia file transfer means; and graphical user interface control means associated with the local computer, the graphical user interface control means being in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

The server computer and the local computer may operatively communicate with one another through the Internet. The system may further comprise compression means associated with the local computer and operatively communicating with the multimedia input device for compressing the multimedia input received and stored by the multimedia input device. The system may further comprise identification tagging means associated with the local computer and operatively communicating with the multimedia input device for tagging with an identifier the multimedia input received and stored by the multimedia input device. The system may further comprise tagged multimedia file management means associated with the local computer and operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

The system may further comprise a stand-alone multimedia file output device operatively communicating with the local computer; and multimedia file output device type detection means associated with the local computer for detecting the type of multimedia file output device operatively communicating with the local computer; wherein the multimedia file transfer means is adapted to transfer the multimedia file between at least two of the mass storage device of the server computer, the fixed mass storage device of the local computer, the removable mass storage device of the local computer, and the multimedia file output device; and wherein the graphical user interface control means operatively communicates with the multimedia file type detection means, the multimedia file output device type detection means, and the graphical user interface generation means for receiving an indication of i) the multimedia file type detected by the multimedia file type detection means and ii) the multimedia file output device type detected by the multimedia file output device type detection means for controlling the graphical user interface generation means to generate a graphical user interface specific to at least one of i) a particular type of multimedia file being transferred by the multimedia file transfer means and ii) a particular type of multimedia file output device operatively communicating with the local computer.

The multimedia file output device and the local computer may operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel. The multimedia file output device may be a plush stuffed toy.

A software program for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another is provided, comprising graphical user interface generation means for generating a graphical user interface through which the functions of the software program are controlled by a user; multimedia file transfer means for transferring the multimedia file between at least two of the mass storage device of the server computer, the fixed mass storage device of the local computer, and the removable mass storage device of the local computer; multimedia file type detection means for detecting the type of multimedia file being transferred by the multimedia file transfer means; and graphical user interface control means in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

The server computer and the local computer may operatively communicate with one another through the Internet. The software program may further comprise compression means operatively communicating with the multimedia input device for compressing the multimedia input received and stored by the multimedia input device. The software program may further comprise identification tagging means operatively communicating with the multimedia input device for tagging with an identifier the multimedia input received and stored by the multimedia input device. The software program may further comprise tagged multimedia file management means operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

Another software program for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another is provided, comprising graphical user interface generation means for generating a graphical user interface through which the functions of the software program are controlled by a user; multimedia file transfer means for transferring the multimedia file between at least two of the mass storage device of the server computer, the fixed mass storage device of the local computer, the removable mass storage device of the local computer, and the multimedia file output device; multimedia file type detection means for detecting the type of multimedia file being transferred by the multimedia file transfer means; multimedia file output device type detection means for detecting the type of multimedia file output device operatively connected to the local computer; and graphical user interface control means operatively connected to the multimedia file type detection means, the multimedia file output device type detection means, and the graphical user interface generation means for receiving an indication of i) the multimedia file type detected by the multimedia file type detection means and ii) the multimedia file output device type detected by the multimedia file output device type detection means for controlling the graphical user interface generation means to generate a graphical user interface specific to at least one of i) a particular type of multimedia file being transferred by the multimedia file transfer means and ii) a particular type of multimedia file output device operatively connected to the local computer.

The server computer and the local computer may operatively communicate with one another through the Internet. The software program may further comprise compression means operatively communicating with the multimedia input device for compressing the multimedia input received and stored by the multimedia input device. The software program may further comprise identification tagging means operatively communicating with the multimedia input device for tagging with an identifier the multimedia input received and stored by the multimedia input device. The software may further comprise tagged multimedia file management means operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

The multimedia file output device and the local computer may operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel. The multimedia file output device may be a plush stuffed toy.

A method for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another is provided, comprising generating a graphical user interface through which the functions of a software program are controlled by a user; transferring the multimedia file between at least two of the mass storage device of the server computer, the fixed mass storage device of the local computer, and the removable mass storage device of the local computer; detecting the type of multimedia file being transferred; and modifying the graphical user interface into a form specific to a particular type of multimedia file being transferred by the multimedia file transfer means.

The server computer and the local computer may operatively communicate with one another through the Internet. The method may further comprise compressing the multimedia input received and stored by the multimedia input device. The method may further comprise tagging with an identifier the multimedia input received and stored by the multimedia input device. The method may further comprise maintaining a list of approved multimedia file identifiers and prohibiting the transfer to the fixed mass storage device of the local computer of a multimedia file having an identifier which is not contained within the list of approved multimedia file identifiers.

Another method for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another is provided, comprising generating a graphical user interface through which the functions of a software program are controlled by a user; transferring the multimedia file between at least two of the mass storage device of the server computer, the fixed mass storage device of the local computer, the removable mass storage device of the local computer, and the multimedia file output device; detecting the type of multimedia file being transferred; detecting the type of multimedia file output device operatively connected to the local computer; and modifying the graphical user interface into a form specific to at least one of i) a particular type of multimedia file being transferred and ii) a particular type of multimedia file output device operatively connected to the local computer.

The server computer and the local computer may operatively communicate with one another through the Internet. The method may further comprise compressing the multimedia input received and stored by the multimedia input device. The method may further comprise tagging with an identifier the multimedia input received and stored by the multimedia input device. The method may further comprise maintaining a list of approved multimedia file identifiers and prohibiting the transfer to the fixed mass storage device of the local computer of a multimedia file having an identifier which is not contained within the list of approved multimedia file identifiers. The multimedia file output device and the local computer may operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel. The multimedia file output device may be a plush stuffed toy.

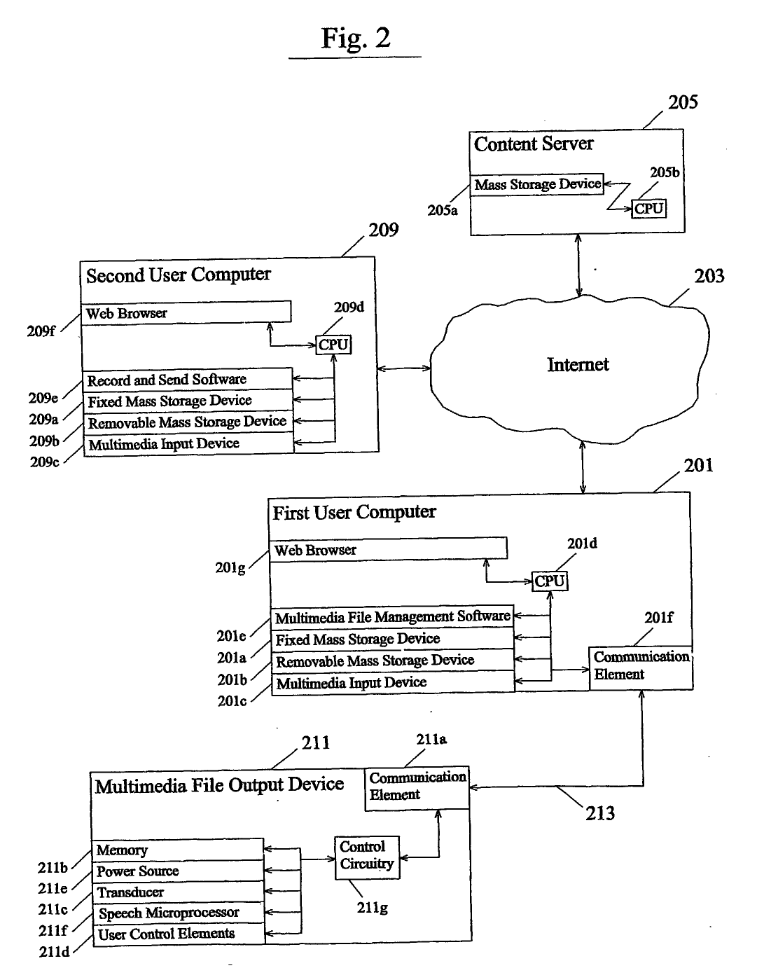

Referring now to FIG. 2, it can be seen that the basic concept of the instant invention is that of a Multimedia File Output Device 211 (preferably in the form of a plush toy, or “stuffed animal”) which can play multimedia files (preferably in the form of audio and/or video data) that are transferred from Fixed Mass Storage Device 201a of First User Computer 201. The multimedia files can be placed on Fixed Mass Storage Device 201a of First User Computer 201 in a number of ways:

1) by downloading the multimedia files from Mass Storage Device 205a of Content Server 205 via the Internet 203;

2) by storing as multimedia files audio and/or video data input by a user to Multimedia Input Device 201c, which preferably takes the form of a microphone and/or video camera;

3) by receiving multimedia files as email attachments, preferably sent from Second User Computer 209 using Record And Send Software 209e (described in detail below); and

4) by transferring multimedia files from Removable Mass Storage Device 201b (preferably an optical disc such as a CD) of First User Computer 201.

A notable feature of the instant invention is that all of the multimedia files associated with the Multimedia File Output Device 211 are preferably stored together on Fixed Mass Storage Device 201a in a “Library” having associated groupings whereby, for example, multimedia files from a given source are stored in a single group or multimedia files targeted to a given type of Multimedia File Output Device 211 are stored in a single group. In support of this feature each multimedia file may contain data identifying a “Library” group to which it belongs and/or a type of Multimedia File Output Device 211 to which is targeted. Alternatively, each multimedia file may have associated with it a “descriptor” file containing data identifying a “Library” group to which both the “descriptor” file and the multimedia file belong and/or data identifying a type of Multimedia File Output Device 211 to which the “descriptor” file and the multimedia file are targeted. In another alternative, entries may be made in the WINDOWS registry to associate particular multimedia file types with particular “Library” groups.

Another notable feature of the instant invention is that the multimedia files associated with the Multimedia File Output Device 211 are in a format optimized for playback through the Multimedia File Output Device 211.

Another notable feature of the instant invention is that the Graphical User Interface presented to the user for transferring the multimedia files is modified in dependence upon the type of multimedia file being transferred (e.g., a multimedia file containing content from DISNEY or a multimedia file containing content from WARNER BROTHERS) and the type of Multimedia File Output Device 211 connected to First User Computer 201 (e.g., a MICKEY MOUSE toy or a BUGS BUNNY toy). Such modification of the Graphical User Interface may be performed dynamically, in real-time, such as when different types of multimedia files are transferred while the inventive system is running or when different types of Multimedia File Output Devices are connected while the inventive system is running.

Turning now to a more detailed examination of the first embodiment of the instant invention shown in FIG. 2, it is seen that First User Computer 201 is connected via the Internet 203 to Content Server 205. Content Server 205 includes Mass Storage Device 205a and CPU 205b. Second User Computer 209 is also connected via the Internet 203 to Content Server 205. Such interconnection of computers via the Internet 203 (using, for example, network adapter cards, not shown) is well known to those of ordinary skill in the art and shall not be discussed further.

Continuing on, it is seen that Multimedia File Output Device 211 is connected to First User Computer 201 through Communication Link 213. Communication Link 213 is preferably formed by a non-permanent link which may be any suitable link such as a hard-wired electrical link, a hard-wired fiber optic link, an infra-red link, a radio-frequency link, or an ultrasonic link, for example. In the case of the above-mentioned hard-wired links it is noted that they may be made non-permanent through the use of appropriate connectors (not shown) at the First User Computer 201 end of the link and/or at the Multimedia File Output Device 211 end of the link. Further, it is noted that Communication Link 213 may be either a serial or parallel link, for example. Again, such communication links are well known to those of ordinary skill in the art and shall not be discussed further.

In any case, it is seen that Multimedia File Output Device 211 includes: i) Communication Element 211a for communicating with First User Computer 201 through Communication Link 213, ii) Memory 211b for storing multimedia files received from First User Computer 201, iii) Transducer 211c (such as a speaker and/or video display, for example) for outputting the content of the multimedia files stored in Memory 211b, iv) User Control Elements 211d (including on/off switch, volume control, start button, stop button, pause button, skip button, rewind button, and fast forward button, for example) for controlling the playback of the multimedia files stored in Memory 211b, v) Power Source 211e (such as a battery, for example), vi) Speech Microprocessor 211f; and vii) Control Circuitry 211g for communicating with First User Computer 201 through Communication Link 213 and for carrying out the commands issued by the user through the User Control Elements 211d.

Regarding Memory 211b, it is noted that this can be comprised of one or more FLASH memory elements, one or more of which may be a plug-in FLASH (i.e., removable). Each FLASH memory element may be a 4Mbit (8×512bit) FLASH. Regarding Speech Microprocessor 211f, it is noted that this can be comprised of either the TEXAS INSTRUMENTS MSP50C605 processor or the TEXAS INSTRUMENTS MSP50C30 processor. Further, it is noted that Multimedia Output Device 211 may include an amplifier (not shown) for powering Transducer 211c. Finally, it is noted that Multimedia File Output Device 211 may have an Automatic Power Down feature built into Control Circuitry 211g to conserve battery life.

Referring now to a more detailed description of First User Computer 201 and Second User Computer 209 it is seen that included with each are, respectively, Fixed Mass Storage Device 201a and 209a (such as a magnetic hard-drive, for example), Removable Mass Storage Device 201b and 209b (such as an optical disc, for example), Multimedia Input Device 201c and 209c (such as an audio and/or video input device, for example), and CPU 201d and 209d. Also included with First User Computer 201 is Multimedia File Management Software 201e, Communication Element 201f (for communicating with Multimedia File Output Device 211 through Communication Link 213), and Web Browser 201g. Included with Second User Computer 209 is Record And Send Software 209e and Web Browser 201f. Additionally, it is noted that First User Computer 201, Second User Computer 209, and Content Server 205 all include computer operating systems (not shown) such as WINDOWS, for example.

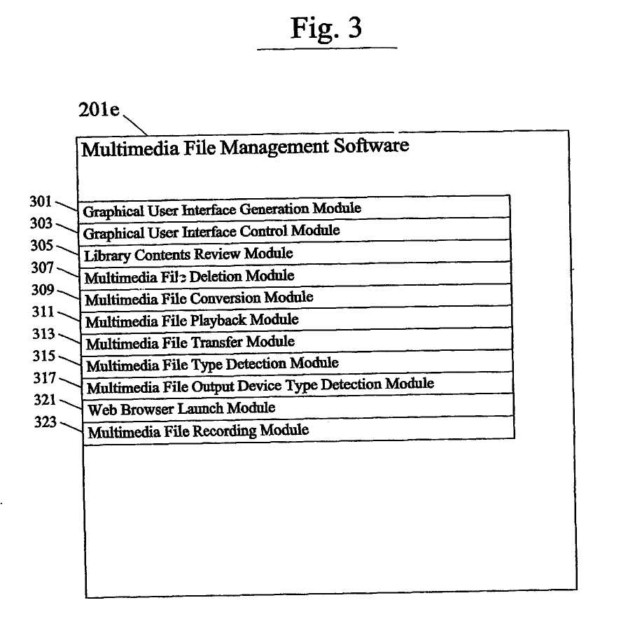

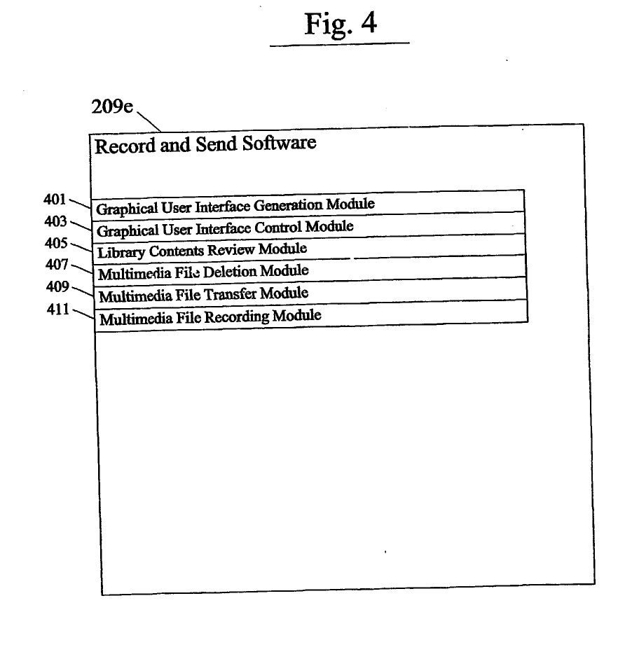

The operation of the first embodiment of the instant invention will now be discussed with reference to FIG. 2 (showing the interconnection of the various components of the first embodiment of the invention) as well as FIG. 3 (showing in block diagram form the elements of the Multimedia File Management Software 201e) and FIG. 4 (showing in block diagram form the elements of Record And Send Software 209e).

To begin with, it is noted that Multimedia File Management Software 201e can be started in a number of ways. In this regard, the WINDOWS operating system allows multiple Start Menu entries and corresponding Desktop Shortcut Icons for each software program. Thus, one way to start the Multimedia File Management Software 201e is through the Start Menu or Desktop of the WINDOWS operating system. When started this way, that is, using the Start Menu or a Desktop Shortcut Icon, the Multimedia File Management Software 201e will present a Graphical User Interface appropriate to the Multimedia File Output Device 211 connected to First user Computer 201 (if connected) or a default Graphical User Interface corresponding to the particular Start Menu choice or Desktop Shortcut Icon used (if no Multimedia File Output Device 211 is connected).

Another way to start Multimedia File Management Software 201e involves the use of Web Browser 201g. A website (not shown) on Content Server 205 will contain a multimedia file to be downloaded as well as a “descriptor” file corresponding thereto. A link on the website will point to the “descriptor” file. When Web Browser 201g is used to click on the “descriptor” file link a number of things will happen. First, the “descriptor” file will be downloaded to the WINDOWS Temp directory. Next, the Multimedia File Management Software 201e will be started. Next, the Multimedia File Management Software 201e will look at the “descriptor” file to find the name, location, and type of the multimedia file. Finally, the Multimedia File Management Software 201e will download the multimedia file using a file-specific Graphical User Interface. It is noted that if Multimedia File Management Software 201e is already running when the Web Browser 201g is used to start a file download then Multimedia File Management Software 201e simply takes over the downloading of the multimedia file as discussed above without having to first be started.

In any case, as seen in FIG. 3, Multimedia File Management Software 201e includes:

1) Graphical User Interface Generation Module 301 for generating a Graphical User Interface;

2) Graphical User Interface Control Module 303 for controlling the Graphical User Interface Generation Module 301;

3) Library Contents Review Module 305 for providing a user with a listing of multimedia files contained within the Library;

4) Multimedia File Deletion Module 307 for deleting multimedia files from the Library;

5) Multimedia File Conversion Module 309 for converting standard multimedia files (such as WAV files, for example) into a format optimized for playback through the Multimedia File Output Device 211;

6) Multimedia File Playback Module 311 for playing back multimedia files through a speaker (not shown) and/or a monitor (not shown) of First User Computer 201;

7) Multimedia File Transfer Module 313 for transferring multimedia files among First User Computer 201, Multimedia File Output Device 211, Second User Computer 209, and Content Server 205;

8) Multimedia File Type Detection Module 315 for detecting the type of multimedia file being transferred by the Multimedia File Transfer Module 313;

9) Multimedia File Output Device Type Detection Module 317 for detecting the type of Multimedia File Output Device 211 communicating with First User Computer 201;

10) Web Browser Launch Module for “launching”, that is, starting program execution of, Web Browser 201g; and

11) Multimedia File Recording Module 323 for recording a multimedia file based on input to Multimedia Input Device 201c.

Each of the above-mentioned modules cooperates as described below to provide the user the following choices (through the Graphical User Interface generated by the Graphical User Interface Generation Module 301):

1) Review the contents of a multimedia file “Library” (that is, as discussed above, a collection of multimedia files stored on the Fixed Mass Storage Device 201b). The necessary functionality is provided by Library Contents Review Module 305.

2) Select a multimedia file from the “Library” to transfer to the Multimedia File Output Device 211. The files may be selected and transferred individually or a “playlist” may be utilized, whereby multiple files are selected and organized and then transferred all at once in a batch process. The necessary functionality is provided by Multimedia File Transfer Module 313.

3) Record a multimedia file from the Multimedia Input Device 201c and store it in the “Library”. The user may start and stop the recording process as well as playback the recording. In addition, the user may name the recording. The necessary functionality is provided by Multimedia File Recording Module 323.

4) Import a WAV file (i.e., an audio multimedia file in the WAV format) from the Fixed Mass Storage Device 201a and save it in the “Library” in a Multimedia File Output Device Compatible Format. The necessary functionality is provided by Multimedia File Conversion Module 309.

5) Email a multimedia file from the “Library” to a recipient. The necessary functionality is provided by Multimedia File Transfer Module 313. 6) Select a multimedia file from the “Library” to upload to Content Server 205. The necessary functionality is provided by Multimedia File Transfer Module 313.

7) “Launch” stand-alone Web Browser 201g to search the Internet for appropriate multimedia files to download. Upon launch the Web Browser may be directed to automatically navigate to a URL (Uniform Resource Locator) containing multimedia files targeted to the type of Multimedia File Output Device 211 connected to First Computer 201. The necessary functionality is provided by Web Browser Launch Module 321, Multimedia File Transfer Module 313, and Multimedia File Output Device Type Detection Module 317.

8) Select a multimedia file from the “Library” and output it through the speaker (not shown) of First User Computer 201 and/or the monitor (not shown) of First User Computer 201. The user may be allowed to play back the entire multimedia file or only a portion thereof (for preview purposes). The necessary functionality is provided by Multimedia File Playback Module 311.

9) Delete a multimedia file from the “Library”. The necessary functionality is provided by Multimedia File Deletion Module 307.

In operation, a user simply selects the desired choice from the Graphical User Interface provided by the Graphical User Interface Generation Module 301 of Multimedia File Management Software 201e. For example, to transfer a multimedia file from the “Library” to Memory 211b of Multimedia File Output Device 211 for later playback the user simply selects choice number 2 above.

As seen in FIG. 4, Record And Send Software 209e provides a subset of the elements and functionality provided by Multimedia File Management Software 201e. Where the elements and functionality provided by Record And Send Software 209e match those provided by Multimedia File Management Software 201e they are carried out in a similar manner, with the following exceptions. Unlike Multimedia File Transfer Module 313, Multimedia File Transfer Module 409 does not provide functionality for: i) transferring a multimedia file to Multimedia File Output Device 211 and ii) downloading a multimedia file from the Internet 203. In other respects, however, it operates in a similar manner.

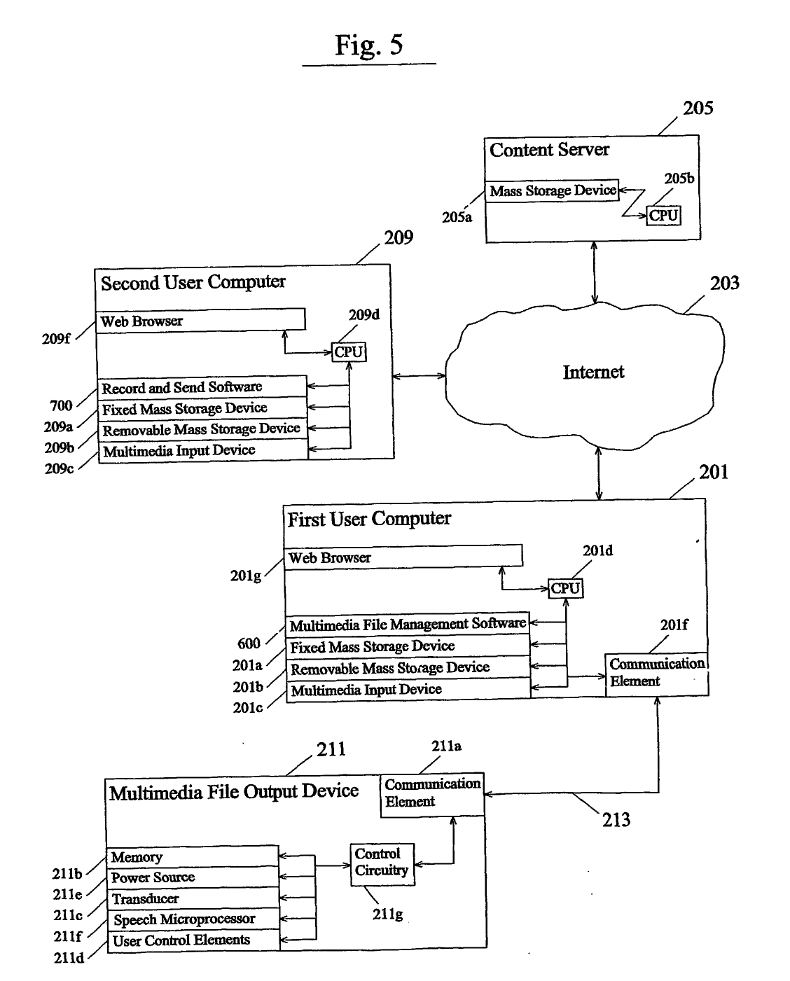

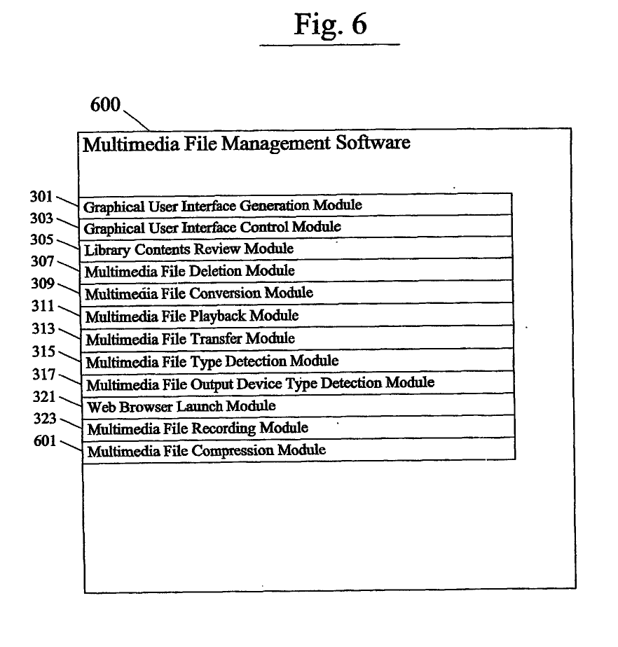

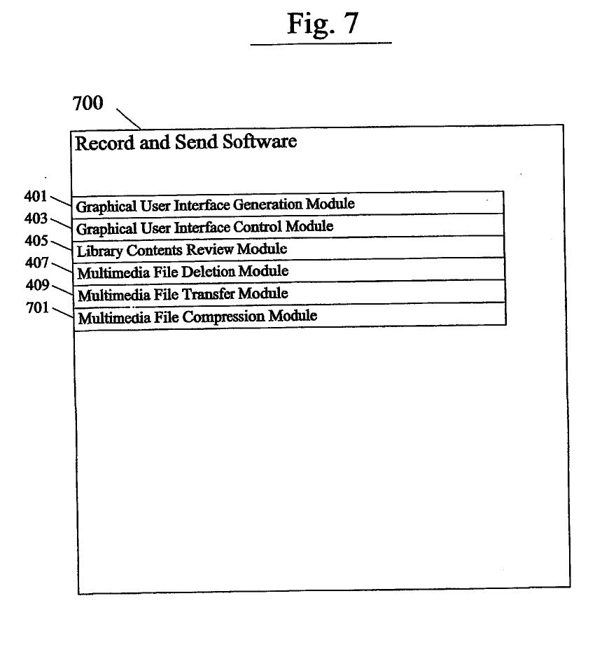

Referring now to FIGS. 5, 6, and 7, a second embodiment of the instant invention is shown. This second embodiment is similar to the first embodiment with the distinctions being that: i) the Multimedia File Management Software 600 further includes Multimedia File Compression Module 601 (shown in FIG. 6); and ii) the Record And Send Software 700 further includes Multimedia File Compression Module 701 (shown in FIG. 7). All of the other elements of FIGS. 5, 6, and 7 correspond in structure and function to those of FIGS. 2, 3, and 4 and shall not be discussed further.

In operation, the Multimedia File Compression Module 601 preferably works without user intervention by compressing data received from the Multimedia Input Device 201c “on-the-fly” before it is stored in a compressed format as a multimedia file. Alternatively, the user may be permitted to turn the compression on and off through the Graphical User Interface provided by Graphical User Interface Generation Module 301. Of course, the Multimedia File Compression Module 701 of Record And Send Software 700 operates in a similar fashion.

It is noted that while the compression is preferably performed “on-the-fly” it may alternatively be performed “off-line”, wherein the data is first stored as an uncompressed multimedia file and then compressed at a later time. Further, it is noted that the compression can be performed at different bit/sec rates depending upon the data being compressed Preferable compression rates include 3Kbit/sec, 6.2Kbit/sec, 7.7Kbit/sec, and 11.2Kbit/sec.

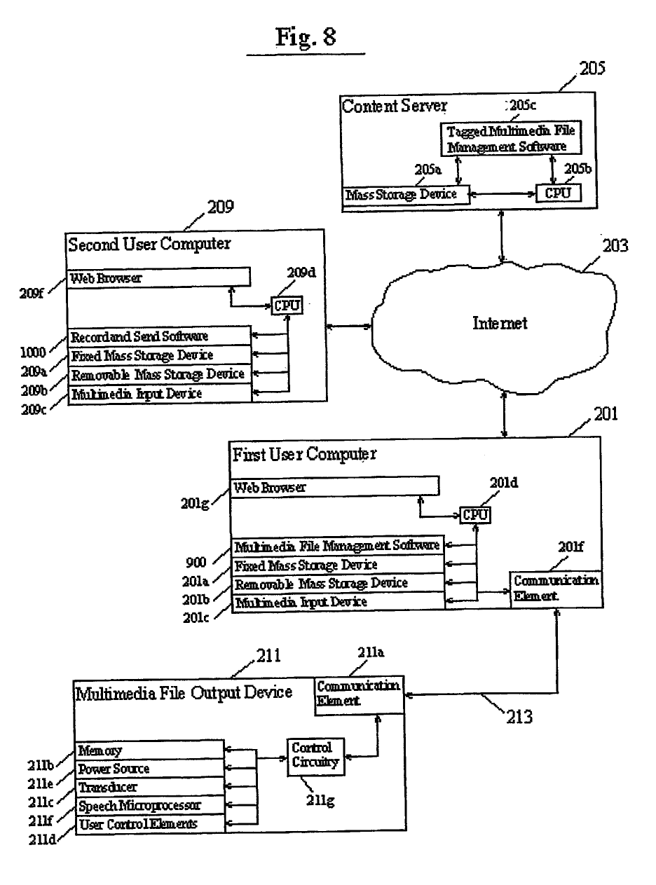

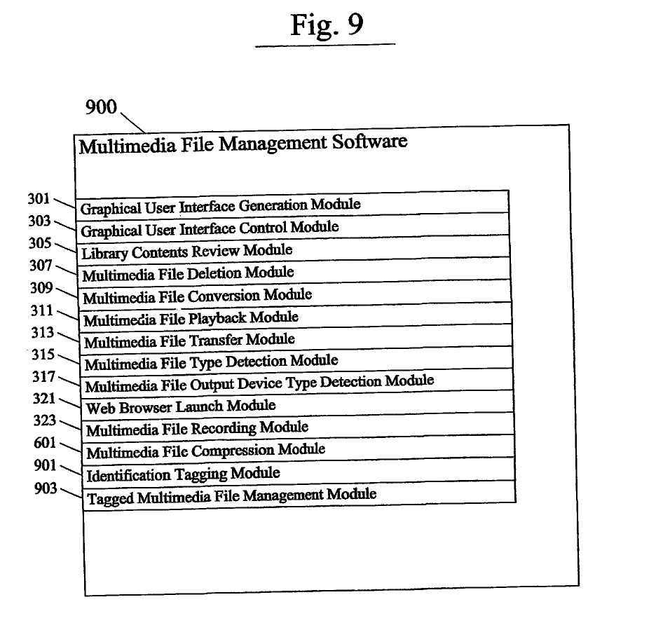

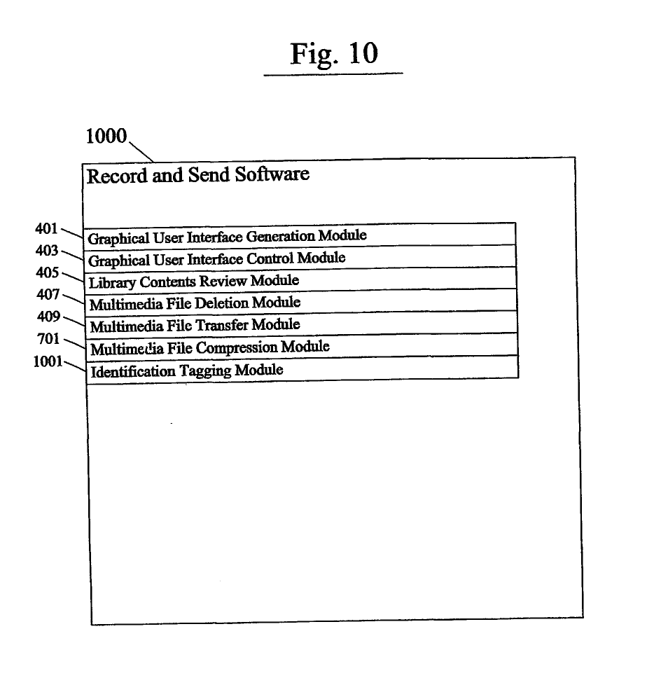

Referring now to FIGS. 8, 9, and 10, a third embodiment of the instant invention is shown. This third embodiment is similar to the second embodiment with the distinctions being that: i) the Multimedia File Management Software 900 further includes Identification Tagging Module 901 and Tagged Multimedia File Management Module 903 (both shown in FIG. 9); ii) the Record And Send Software 1000 further includes Identification Tagging Module 1001; and iii) the Content Server 205 further includes Tagged Multimedia File Management Software 205b. All of the other elements of FIGS. 8, 9, and 10 correspond in structure and function to those of FIGS. 5, 6, and 7 and shall not be discussed further.

In operation, the Identification Tagging Module 901 preferably works without user intervention by tagging with an identifier data received from the Multimedia Input Device 201c. In the alternative, the tagging may be performed when directed by the user through the Graphical User Interface provided by Graphical User Interface Generation Module 301. In any case, the identifier may preferably include the following information: the user's name, the user's age, the city in which the user resides, the user's email address, a description of the multimedia file, and additional comments. The information may be input by the user each time it is required or it may be stored in a database and accessed as needed. Of course, the Identification Tagging Module 1001 of Record And Send Software 1000 operates in a similar fashion.

Turning now to the Tagged Multimedia File Management Module 903, it is noted that this element of Multimedia File Management Software 900 maintains a list of approved multimedia file identifiers and prohibits the transfer to the Fixed Mass Storage Device 201a of a multimedia file having an identifier which is not contained within the list of approved multimedia file identifiers. The list of approved multimedia file identifiers may be password protected and may be manipulated under user direction provided through Graphical User Interface Generation Module 301.

Further, with regard to Tagged Multimedia File Management Software 205c of Content Server 205 it is noted that this element provides an “inbox” area on Mass Storage Device 205a for holding incoming multimedia files transferred thereto from First User Computer 201 and Second User Computer 209 and an “outbox” area on Mass Storage Device 205a for holding multimedia files moved from the “inbox” area after review by an operator of Content Server 205. The Tagged Multimedia File Management Software 205a is preferably configured to allow uploads only to the “inbox” area and downloads only from the “outbox” area. This will insure that only multimedia files which the operator of Content Server 205 has reviewed and deemed appropriate can be downloaded from Content Server 205.

While a number of embodiments of the instant invention have been described, it is understood that these embodiments are illustrative only, and not restrictive, and that many modifications may become apparent to those of ordinary skill in the art. For example, while the instant invention has been described principally with reference to the WINDOWS operating system, it may be applied to systems running any appropriate operating system such as the MACINTOSH operating system, the LINIX operating system, or the UNIX operating system, for example. Further, while the instant invention has been described principally with reference to two user computers and one server computer any other appropriate number of user computers and/or server computers may be utilized. Further still, while the transferring of multimedia files among the server computer, the user computers, and the multimedia file output device has been described principally with reference to World Wide Web downloads and email transfers any other appropriate transfer mechanism may be used, such as FTP transfer, for example. Further still, the email functionality of the instant invention may be carried out using the MAPI (Mail Application Program Interface) standard and the WINDOWS registry may contain one or more entries to automatically launch the Multimedia File Management Software whenever an email attachment containing a multimedia file associated with the invention is selected in a stand-alone email program. Further still, while the instant invention has been described with reference to converting a WAV file for use therewith it is noted that any other appropriate multimedia file may of course be converted and used. Further still, a data-enabled wireless telephone may be utilized in place of the described user computers to transfer multimedia files according to the invention.

What is claimed is:

1. A system for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another, comprising:
graphical user interface generation means associated with the local computer for generating a graphical user interface through which the functions of the system are controlled by a user;
multimedia file transfer means associated with the local computer for transferring the multimedia file between at least two of the mass storage device of the server computer, the fixed mass storage device of the local computer, and the removable mass storage device of the local computer;
multimedia file type detection means associated with the local computer for detecting the type of multimedia file being transferred by the multimedia file transfer means; and
graphical user interface control means associated with the local computer, the graphical user interface control means being in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

2. The system of claim 1, wherein the server computer and the local computer operatively communicate with one another through the Internet.

3. The system of claim 1, further comprising compression means associated with the local computer and operatively communicating with the multimedia input device for compressing the multimedia input received and stored by the multimedia input device.

4. The system of claim 1, further comprising identification tagging means associated with the local computer and operatively communicating with the multimedia input device for tagging with an identifier the multimedia input received and stored by the multimedia input device.

5. The system of claim 4, further comprising tagged multimedia file management means associated with the local computer and operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

6. The system of claim 1, further comprising:
a stand-alone multimedia file output device operatively communicating with the local computer; and
multimedia file output device type detection means associated with the local computer for detecting the type of multimedia file output device operatively communicating with the local computer,
wherein the multimedia file transfer means is adapted to transfer the multimedia file between at least two of the mass storage device of the server computer, the fixed mass storage device of the local computer, the removable mass storage device of the local computer, and the multimedia file output device; and
wherein the graphical user interface control means operatively communicates with the multimedia file type detection means, the multimedia file output device type detection means, and the graphical user interface generation means for receiving an indication of i) the multimedia file type detected by the multimedia file type detection means and ii) the multimedia file output device type detected by the multimedia file output device type detection means for controlling the graphical user interface generation means to generate a graphical user interface specific to at least one of i) a particular type of multimedia file being transferred by the multimedia file transfer means and ii) a particular type of multimedia file output device operatively communicating with the local computer.

7. The system of claim 6, wherein the multimedia file output device and the local computer operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel.

8. The system of claim 7, wherein the multimedia file output device is a plush stuffed toy.

9. A software program for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another, comprising:
graphical user interface generation means for generating a graphical user interface through which the functions of the software program are controlled by a user;
multimedia file transfer means for transferring the multimedia file between at least two of the mass storage device of the server computer, the fixed mass storage device of the local computer, and the removable mass storage device of the local computer;
multimedia file type detection means for detecting the type of multimedia file being transferred by the multimedia file transfer means; and
graphical user interface control means in operative communication with the multimedia file type detection means and the graphical user interface generation means for receiving an indication of the multimedia file type detected by the multimedia file type detection means and for controlling the graphical user interface generation means to generate a graphical user interface specific to a particular type of multimedia file being transferred by the multimedia file transfer means.

10. The software program of claim 9, wherein the server computer and the local computer operatively communicate with one another through the Internet.

11. The software program of claim 9, further comprising compression means operatively communicating with the multimedia input device for compressing the multimedia input received and stored by the multimedia input device.

12. The software program of claim 9, further comprising identification tagging means operatively communicating with the multimedia input device for tagging with an identifier the multimedia input received and stored by the multimedia input device.

13. The software program of claim 12, further comprising tagged multimedia file management means operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

14. A software program for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another, comprising:
graphical user interface generation means for generating a graphical user interface through which the functions of the software program are controlled by a user;
multimedia file transfer means for transferring the multimedia file between at least two of the mass storage device of the server computer, the fixed mass storage device of the local computer, the removable mass storage device of the local computer, and the multimedia file output device;
multimedia file type detection means for detecting the type of multimedia file being transferred by the multimedia file transfer means;
multimedia file output device type detection means for detecting the type of multimedia file output device operatively connected to the local computer; and
graphical user interface control means operatively connected to the multimedia file type detection means, the multimedia file output device type detection means, and the graphical user interface generation means for receiving an indication of i) the multimedia file type detected by the multimedia file type detection means and ii) the multimedia file output device type detected by the multimedia file output device type detection means for controlling the -graphical user interface generation means to generate a graphical user interface specific to at least one of i) a particular type of multimedia file being transferred by the multimedia file transfer means and ii) a particular type of multimedia file output device operatively connected to the local computer.

15. The software program of claim 14, wherein the server computer and the local computer operatively communicate with one another through the Internet.

16. The software program of claim 14, further comprising compression means operatively communicating with the multimedia input device for compressing the multimedia input received and stored by the multimedia input device.

17. The software program of claim 14, further comprising identification tagging means operatively communicating with the multimedia input device for tagging with an identifier the multimedia input received and stored by the multimedia input device.

18. The software program of claim 17, further comprising tagged multimedia file management means operatively communicating with the multimedia file transfer means for maintaining a list of approved multimedia file identifiers and for prohibiting the transfer to the fixed mass storage device of the local computer of a multimedia file having an identifier which is not contained within the list of approved multimedia file identifiers.

19. The software program of claim 14, wherein the multimedia file output device and the local computer operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel.

20. The software program of claim 19, wherein the multimedia file output device is a plush stuffed toy.

21. A method for transferring a multimedia file between i) a server computer having a mass storage device capable of storing the multimedia file and ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, wherein the server computer and the local computer operatively communicate with one another, comprising:
generating a graphical user interface through which the functions of a software program are controlled by a user;
transferring the multimedia file between at least two of the mass storage device of the server computer, the fixed mass storage device of the local computer, and the removable mass storage device of the local computer;
detecting the type of multimedia file being transferred; and
modifying the graphical user interface into a form specific to a particular type of multimedia file being transferred by the multimedia file transfer means.

22. The method of claim 21, wherein the server computer and the local computer operatively communicate with one another through the Internet.

23. The method of claim 21, further comprising compressing the multimedia input received and stored by the multimedia input device.

24. The method of claim 21, further comprising tagging with an identifier the multimedia input received and stored by the multimedia input device.

25. The method of claim 24, further comprising:
maintaining a list of approved multimedia file identifiers; and
prohibiting the transfer to the fixed mass storage device of the local computer of a multimedia file having an identifier which is not contained within the list of approved multimedia file identifiers.

26. A method for transferring a multimedia file among i) a server computer having a mass storage device capable of storing the multimedia file, ii) a local computer having a fixed mass storage device capable of storing the multimedia file, a removable mass storage device capable of storing the multimedia file, and a multimedia input device for receiving multimedia input and storing the multimedia input on the fixed mass storage device of the local computer in the form of a multimedia file, and iii) a stand-alone multimedia file output device, wherein the server computer and the local computer operatively communicate with one another and the local computer and the multimedia file output device operatively communicate with one another, comprising:
generating a graphical user interface through which the functions of a software program are controlled by a user;
transferring the multimedia file between at least two of the mass storage device of the server computer, the fixed mass storage device of the local computer, the removable mass storage device of the local computer, and the multimedia file output device;
detecting the type of multimedia file being transferred;
detecting the type of multimedia file output device operatively connected to the local computer; and
modifying the graphical user interface into a form specific to at least one of i) a particular type of multimedia file being transferred and ii) a particular type of multimedia file output device operatively connected to the local computer.

27. The method of claim 26, wherein the server computer and the local computer operatively communicate with one another through the Internet.

28. The method of claim 26, further comprising compressing the multimedia input received and stored by the multimedia input device.

29. The method of claim 26, further comprising tagging with an identifier the multimedia input received and stored by the multimedia input device.

30. The method of claim 29, further comprising:
maintaining a list of approved multimedia file identifiers; and
prohibiting the transfer to the fixed mass storage device of the local computer of a multimedia file having an identifier which is not contained within the list of approved multimedia file identifiers.

31. The method of claim 26, wherein the multimedia file output device and the local computer operatively communicate through a non-permanent connection selected from the group of: i) a hard-wired electrical communication channel, ii) a hard-wired fiber optic communication channel, iii) an infra-red communication channel, iv) a radio-frequency communication channel, and v) an ultrasonic communication channel.

32. The method of claim 31, wherein the multimedia file output device is a plush stuffed toy.
